(19) United States
(12) Patent Application Publication
(10) Pub. No.: US 2022/0057498 A1
(43) Pub. Date: Feb. 24, 2022

(54) DETECTING PRESENCE OF A MOVING OBJECT WITH AN ULTRASONIC TRANSDUCER

(71) Applicant: Chirp Microsystems, Inc., Berkeley, CA (US)

(72) Inventors: Agnes DUVAL, Grenoble (FR); Joe YOUSSEF, Noyarey (FR)

(73) Assignee: Chirp Microsystems, Inc., Berkeley, CA (US)

(21) Appl. No.: 16/999,179

(22) Filed: Aug. 21, 2020

(51) Int. Cl. G01S 7/527; G01S 15/42; G01S 7/539

(52) U.S. Cl. CPC G01S 7/5273; G01S 7/539; G01S 15/42

(57) ABSTRACT

A device comprises a processor coupled with an ultrasonic transducer which is configured to emit an ultrasonic pulse and receive corresponding returned signals associated with a distance range of interest in a field of view of the ultrasonic transducer. The processor is configured to: remove a low frequency component from the returned signals to achieve modified returned signals; calculate, from the modified returned signals, a variation in amplitude; determine a quantification of the variation in amplitude for a first subset of the modified returned signals associated with a first subrange of the distance range of interest; employ the quantification to correct for changes in the first subset to achieve first normalized sensor data for the first subrange, where the first normalized sensor data is sensitive to occurrence of change over time in the first subrange; and detect a moving object in the first subrange using the first normalized sensor data.

### BACKGROUND

A variety of devices exist which utilize sonic sensors (e.g., sonic emitters and receivers, or sonic transducers). By way of example, and not of limitation, a device may utilize one or more sonic sensors to track the location of the device in space, to detect the presence of objects in the environment of the device, and/or to avoid objects in the environment of the device. Such sonic sensors include transmitters which transmit sonic signals, receivers which receive sonic signals, and transducers which both transmit sonic signals and receive sonic signals. Many of these sonic transducers emit signals in the ultrasonic range, and thus may be referred to as ultrasonic transducers. Piezoelectric Micromachined Ultrasonic Transducers (PMUTs), which may be air-coupled, are one type of sonic transducer, which operates in the ultrasonic range. The sonic transducer(s) may be part of a microelectromechanical system (MEMS). Sonic transducers, including ultrasonic transducers, can be used for a large variety of sensing applications such as, but not limited to: virtual reality controller tracking, presence detection, object detection/location, and object avoidance. For example, drones, robots, security systems or other devices may use ultrasonic transducers and/or other sonic transducers in any of these or numerous other applications.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIGS. 1A and 1B show example block diagrams of some aspects of a device which includes a sonic transducer, in accordance with various embodiments.

FIG. 2A shows an example external depiction of a device using an ultrasonic transducer to detect for objects a sensed environment, in accordance with various embodiments.

FIG. 2B shows an example external depiction of a device using an ultrasonic transducer to detect for objects a sensed environment into which a new object has entered, in accordance with various embodiments.

FIG. 2C shows an example external depiction of a device using an ultrasonic transducer to detect for objects a sensed environment with a moving object, in accordance with various embodiments.

FIG. 2D shows an example external depiction of a device using an ultrasonic transducer to detect for objects a sensed environment, in accordance with various embodiments.

FIG. 3 illustrates a flow diagram of a method of detecting the presence of a moving object with an ultrasonic transducer, in accordance with various embodiments.

FIG. 4 illustrates a graph of raw magnitudes of returned signals received over a period of time by an ultrasonic transducer in a sensed environment such as a room, in accordance with various embodiments.

FIG. 5 illustrates a graph of modified returned signals after a low frequency component has been removed from the returned signals of FIG. 4, in accordance with various embodiments.

FIG. 6 illustrates a more detailed view of the functions of the adaptive learning portion of the flow diagram of FIG. 3, in accordance with various embodiments.

FIG. 7 illustrates a graph of normalized sensor data after set of modified returned signals has been corrected using variances calculated for the modified returned signals, in accordance with various embodiments.

FIG. 8 illustrates a more detailed view of some aspects of the object detection portion of the flow diagram of FIG. 3, in accordance with various embodiments.

FIGS. 9A-9C illustrate a flow diagram of a method of detecting presence of a moving object with an ultrasonic transducer, in accordance with various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope of the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview of Discussion

Sonic transducers, which include ultrasonic transducers, emit a pulse (e.g., an ultrasonic sound) and then receive returned signals (i.e., echoes) after the ultrasonic waves from the emitted sound are reflected of objects or persons. In this manner, the returned signals correspond to the emitted pulse. Consider a transducer which has part of its duty cycle devoted to emitting a pulse or other signals and another part of its duty cycle devoted to receiving returned signals which are echoes of the emitted pulse/signals. In such a transducer, the returned signals can be used to detect the presence and/or location of objects from which the emitted pulse reflects and then returns to the transducer as a returned signal. In other instances, a first ultrasonic transducer may emit a pulse and the echoing returned signals are received by a second ultrasonic transducer. In some instances ultrasonic transducers have difficulty detecting moving objects, such as the presence of a person walking into a room, in an indoor sensing environment. This difficulty is due to a variety of factors which cause natural variability in the returned signals (i.e., echoes) received by an ultrasonic transducer in an indoor environment; factors which make it hard to know with certainty what object has reflected a returned signal. Some non-limiting examples of such factors may include, but are not limited to, one or more of: sensor noise, temperature variations, air flow, and occasional displacement of objects in the room where the ultrasonic transducer is sensing. In an indoor environment, the returned signals received by an ultrasonic transducer naturally have a good amount of variability for reasons previously mentioned. Because this variation in returned signals can be very different over different periods, setting a general threshold to detect motion or to detect presence of a new object results in frequent false positives and/or false negatives in such detection.

Herein, adaptive background learning techniques are described which allow ultrasonic transducers to overcome issues which detract from their use in detection of the presence of new/moving objects in an indoor space such as a room. Through the use of adaptive background learning techniques described herein, received returned signals from non-moving objects in a sensed environment (e.g., an indoor space such as a room in a building) and numerous unwanted signal contributions which cause wide variability in the received returned signals can be removed and/or reduced to create normalized data which is adapted to a constant background of an indoor space. Because the described techniques remove and/or reduce variability in returned signals caused by other aspects besides the presence of a moving object, the techniques allow the returned signals from a moving object to be more readily discerned in the normalized data, so that the presence of the moving object (i.e., a human, an animal, a vehicle, robot, etc.) can be detected with greater ease. These techniques also allow for automatic adaptation to a changed background if the sensed environment changes (e.g., furniture is repositioned in a room). In some instances, the described techniques facilitate smaller ultrasonic transducers being used to replace or complement comparatively larger passive infrared sensors in devices which perform motion detection, such as in indoor environments. This may reduce the size of the devices and/or improve the overall quality of motion detection of the devices.

Herein, a variety of methods, sonic transducers, devices, and techniques are described for detecting presence of a moving object with an ultrasonic transducer. Although this technology is described herein with reference to ultrasonic transducers, it is broadly applicable to any sonic transducer which might be similarly utilized. In the detailed description, the technology is described with examples in which sonic pulses are emitted and received by a single transducer, however the technology may be implemented with a transducer which emits sonic pulses and one or more other transducers which receive returned signals that result from the emissions. Though the sensed environment where detection of moving objects takes place is often referred to as a room or indoor space in this detailed description, it should be appreciated that the techniques described are applicable to other environments.

Discussion begins with a description of notation and nomenclature. Discussion then shifts to description of some block diagrams of example components of an example devices and a sensor processing unit which may utilize an ultrasonic transducer (or other sonic transducer). The device may be any type of device which utilizes sonic sensing, for example any device which uses ultrasonic transducers may employ the techniques and methods described herein. Discussion then moves to description of a device using a sonic transducer to detect for objects in an environment and within a distance range of interest from the ultrasonic transducer. Returned signals from an emitted pulse are discussed along with methods for utilizing the returned signals to detect a moving object in an environment of the sonic transducer. Finally, operation of the device, sensor processor, and/or components thereof are described in conjunction with description of a method of detecting presence of a moving object with an ultrasonic transducer.

### Notation and Nomenclature

Some portions of the detailed descriptions which follow are presented in terms of procedures, logic blocks, processes, modules and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “accessing,” “calculating,” “comparing,” “detecting,” “deteriorating,” “determining,” “employing,” “estimating,” “normalizing,” “obtaining,” “pausing,” “quantifying,” “receiving returned signals from an ultrasonic transducer,” “removing,” or the like, may refer to the actions and processes of an electronic device or component such as: a host processor, a sensor processing unit, a sensor processor, a digital signal processor (DSP), an application specific integrated circuit (ASIC), an application specific instruction set processors (ASIP), a field programmable gate arrays (FPGA), a controller or other processor, a memory, some combination thereof, or the like. The electronic device/component manipulates and transforms data represented as physical (electronic and/or magnetic) quantities within the registers and memories into other data similarly represented as physical quantities within memories or registers or other such information storage, transmission, processing, or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer or electronic device to perform one or more of the methods described herein. The non-transitory processor-readable data storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as host processor(s) or core(s) thereof, DSPs, general purpose microprocessors, ASICs, ASIPs, FPGAs, sensor processors, microcontrollers, or other equivalent integrated or discrete logic circuitry. The term “processor” or the term “controller” as used herein may refer to any of the foregoing structures, any other structure suitable for implementation of the techniques described herein, or a combination of such structures. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

In various example embodiments discussed herein, a chip is defined to include at least one substrate typically formed from a semiconductor material. A single chip may for example be formed from multiple substrates, where the substrates are mechanically bonded to preserve the functionality. Multiple chip (or multi-chip) includes at least two substrates, wherein the two substrates are electrically connected, but do not require mechanical bonding.

A package provides electrical connection between the bond pads on the chip (or for example a multi-chip module) to a metal lead that can be soldered to a printed circuit board (or PCB). A package typically comprises a substrate and a cover. An Integrated Circuit (IC) substrate may refer to a silicon substrate with electrical circuits, typically CMOS circuits but others are possible and anticipated. A MEMS substrate provides mechanical support for the MEMS structure(s). The MEMS structural layer is attached to the MEMS substrate. The MEMS substrate is also referred to as handle substrate or handle wafer. In some embodiments, the handle substrate serves as a cap to the MEMS structure.

Some embodiments may, for example, comprise a sonic transducer. The sonic transducer may be an ultrasonic transducer. This ultrasonic transducer may operate in any suitable ultrasonic range. In some embodiments, the ultrasonic transducer may be or include a Piezoelectric Micromachined Ultrasonic Transducers (PMUT) which may be an air coupled PMUT. In some embodiments, the ultrasonic transducer may include a DSP or other controller or processor which may be disposed as a part of an ASIC which may be integrated into the same package as the ultrasonic transducer. Such packaged embodiments may be referred to as either an “ultrasonic transducer” or an “ultrasonic transducer device.” In some embodiments, the ultrasonic transducer (and any package of which it is a part) may be included in one or more of a sensor processing unit and/or a device which includes a host processor or other controller or control electronics.

### Example Device

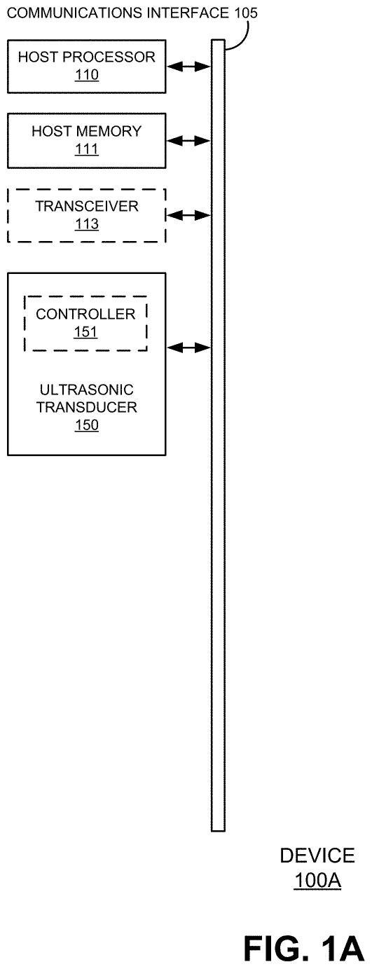

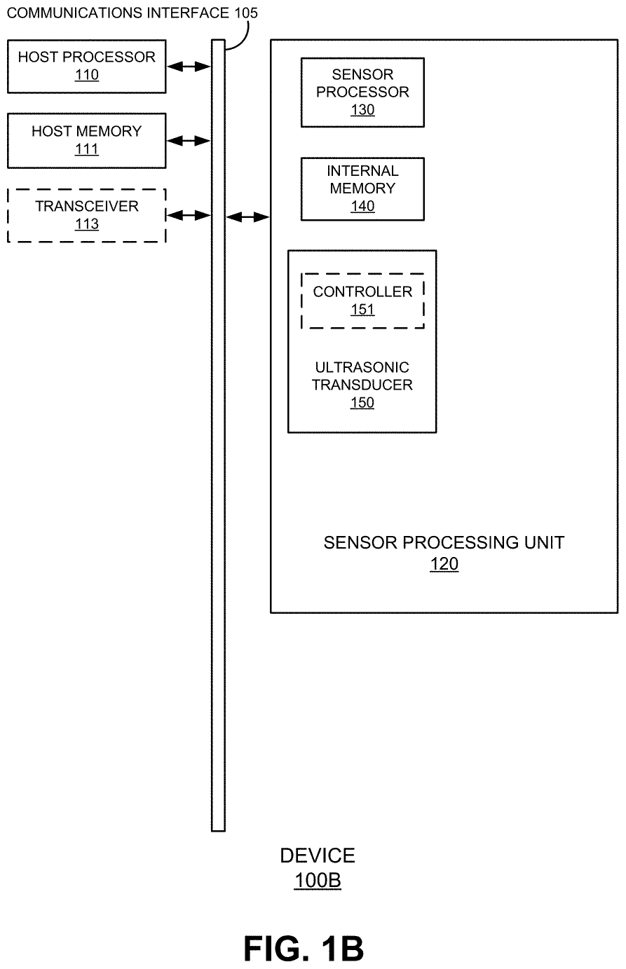

FIGS. 1A and 1B show example block diagrams of some aspects of a device 100 which includes a sonic transducer such as ultrasonic transducer 150, in accordance with various embodiments. Some examples of a device 100 may include, but are not limited to: remote controlled vehicles, virtual reality remotes, a telepresence robot, an electric scooter, an electric wheelchair, a wheeled delivery robot, a flyable drone, a mobile surface vehicle, an automobile, an autonomous mobile device, a floor vacuum, a smart phone, a tablet computer, a security system, a child monitor, and a robotic cleaning appliance. These devices may be generally classified as “moving devices” and “non-moving devices.” A non-moving device is one which is intended to be placed and then remain stationary in that place (e.g., a security sensor). A moving device is one which is self-mobile (e.g., a drone or delivery robot) or which may be moved easily by a human (e.g., a wheelchair, a smartphone, a tablet computer). In various embodiments described herein, the techniques for detecting presence of a moving object may be more readily utilized when a device 100 is stationary even if the device is otherwise self-mobile or easily moved by a human. By way of example, and not of limitation, the device 100 may utilize one or more ultrasonic transducers 150 to track the location of the device 100 in space, to detect the presence of objects in the environment of the device 100, to sense the absence of objects in the environment of device 100, to detect moving objects in the environment of device 100, to characterize objects detected in the environment of device 100, to locate a detected object in two or three dimensional space with respect to the device 100, and/or to avoid objects in the environment of the device 100.

FIG. 1A shows a block diagram of components of an example device 100A, in accordance with various aspects of the present disclosure. As shown, example device 100A comprises a communications interface 105, a host processor 110, host memory 111, and at least one ultrasonic transducer 150. In some embodiments, device 100 may additionally include one a transceiver 113. Though not depicted, some embodiments of device 100A may include one or more additional sensors used to detect motion, position, or environmental context. Some examples of these additional sensors may include, but are not limited to: infrared sensors, cameras, microphones, atmospheric pressure sensors, temperature sensors, and global navigation satellite system sensors (i.e., a global positioning system receiver). As depicted in FIG. 1A, included components are communicatively coupled with one another, such as, via communications interface 105.

The host processor 110 may, for example, be configured to perform the various computations and operations involved with the general function of a device 100. Host processor 110 can be one or more microprocessors, central processing units (CPUs), DSPs, general purpose microprocessors, ASICs, ASIPs, FPGAs or other processors which run software programs or applications, which may be stored in host memory 111, associated with the general and conventional functions and capabilities of device 100. In some embodiments, a host processor 110 may perform some amount of the processing of received returned signals from ultrasonic transducer 150 and/or some aspects of the methods of detecting moving objects that are described herein.

Communications interface 105 may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent and may include a plurality of communications interfaces. Communications interface 105 may facilitate communication between a sensor processing unit (SPU) 120 (see e.g., FIG. 1B) and one or more of host processor 110, host memory 111, transceiver 113, ultrasonic transducer 150, and/or other included components.

Host memory 111 may comprise programs, modules, applications, or other data for use by host processor 110. In some embodiments, host memory 111 may also hold information that that is received from or provided to SPU 120 (see e.g., FIG. 1B). Host memory 111 can be any suitable type of memory, including but not limited to electronic memory (e.g., read only memory (ROM), random access memory (RAM), or other electronic memory). Host memory 111 may include instructions to implement one or more of the methods described herein using host processor 110 and ultrasonic transducer 150.

Transceiver 113, when included, may be one or more of a wired or wireless transceiver which facilitates receipt of data at device 100 from an external transmission source and transmission of data from device 100 to an external recipient. By way of example, and not of limitation, in various embodiments, transceiver 113 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications (or the like) for wireless personal area network communication), and a wired a serial transceiver (e.g., a universal serial bus for wired communication).

Ultrasonic transducer 150 is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as host processor 110. Device 100A may contain a single ultrasonic transducer 150, or may contain a plurality of ultrasonic transducers, for example in the form of an array of ultrasonic transducers. For example, in an embodiment with a single ultrasonic transducer that is used for transmitting (e.g., emitting) and receiving, the ultrasonic transducer may be in an emitting phase for a portion of its duty cycle and in a receiving phase during another portion of its duty cycle.

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals and/or some aspects of the methods of detecting moving objects that are described herein.

FIG. 1B shows a block diagram of components of an example device 100B, in accordance with various aspects of the present disclosure. Device 100B is similar to device 100A except that it includes a sensor processing unit (SPU) 120 in which ultrasonic transducer 150 is disposed. SPU 120, when included, comprises: a sensor processor 130; an internal memory 140; and at least one ultrasonic transducer 150. Though not depicted, in some embodiments, SPU 120 may additionally include one or more motion sensors and/or one or more other sensors such a light sensor, infrared sensor, GNSS sensor, temperature sensor, barometric pressure sensor, microphone, an audio recorder, a camera, etc. In some embodiments SPU 120 may trigger the operation of one or more of these other sensors in response to detecting the presence of a moving object with an ultrasonic transducer 150 (e.g., an audio recorder and/or camera may be triggered to activate). In various embodiments, SPU 120 or a portion thereof, such as sensor processor 130, is communicatively coupled with host processor 110, host memory 111, and/or other components of device 100 through communications interface 105 or other well-known means. SPU 120 may also comprise one or more communications interfaces (not shown) similar to communications interface 105 and used for communications among one or more components within SPU 120.

Sensor processor 130 can be one or more microprocessors, CPUs, DSPs, general purpose microprocessors, ASICs, ASIPs, FPGAs or other processors that run software programs, which may be stored in memory such as internal memory 140 (or elsewhere), associated with the functions of SPU 120. In some embodiments, one or more of the functions described as being performed by sensor processor 130 may be shared with or performed in whole or in part by another processor of a device 100, such as host processor 110. In some embodiments, a sensor processor 130 may perform some amount of the processing of received returned signals and/or some aspects of the methods of detecting moving objects that are described herein.

Internal memory 140 can be any suitable type of memory, including but not limited to electronic memory (e.g., read only memory (ROM), random access memory (RAM), or other electronic memory). Internal memory 140 may store algorithms, routines, or other instructions for instructing sensor processor 130 on the processing of data output by one or more of ultrasonic transducer 150 and/or other sensors. In some embodiments, internal memory 140 may store one or more modules which may be algorithms that execute on sensor processor 130 to perform a specific function. Some examples of modules may include, but are not limited to: statistical processing modules, motion processing modules, object detection modules, object location modules, and/or decision-making modules. Modules may include instructions to implement one or more of the methods described herein using host processor 110, sensor processor 130, and or controller 151.

Ultrasonic transducer 150, as previously described, is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as sensor processor 130 and/or host processor 110. Ultrasonic transducer 150 is communicatively coupled with sensor processor 130 by a communications interface (such as communications interface 105), bus, or other well-known communication means.

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals, may perform some aspects of the methods of detecting moving objects that are described herein, and/or may interpret and carryout instructions received from external to ultrasonic transducer 150.

### Example Device in a Sensed Environment

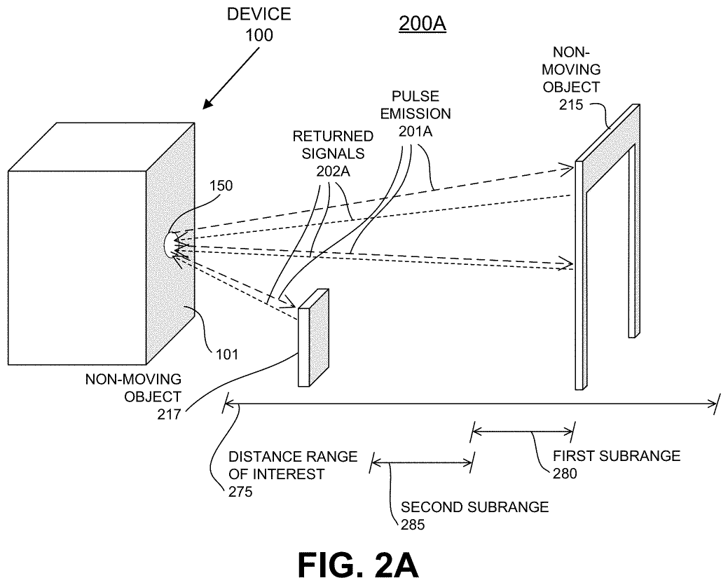

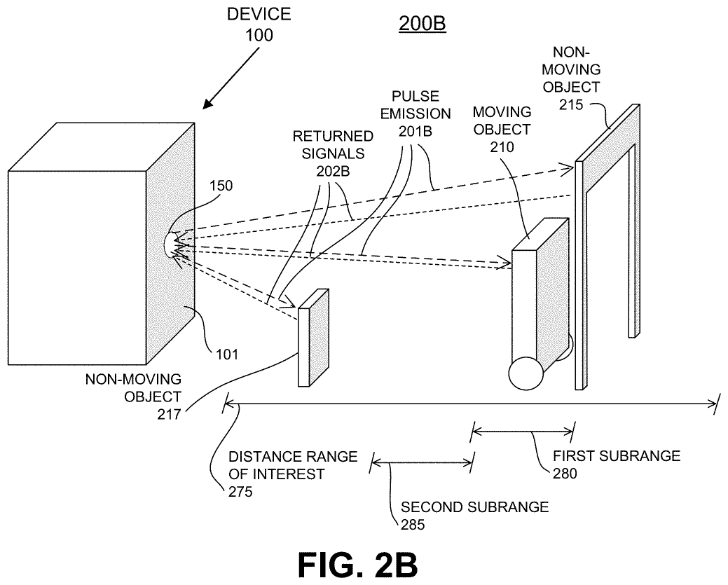

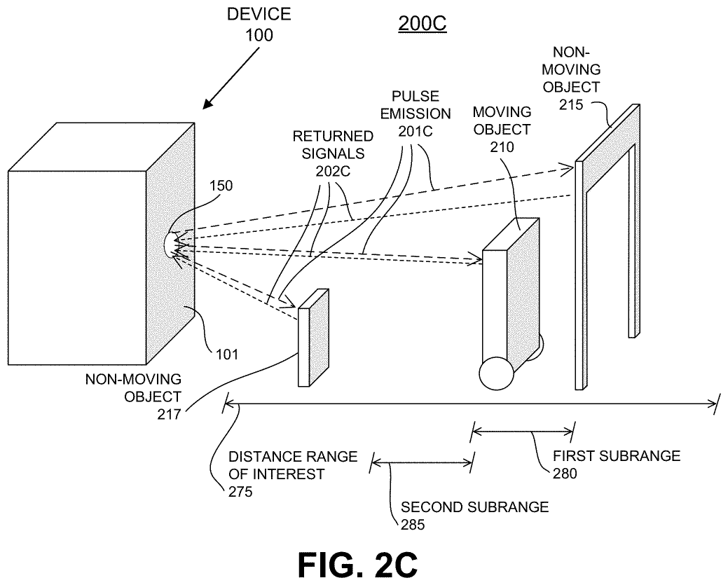

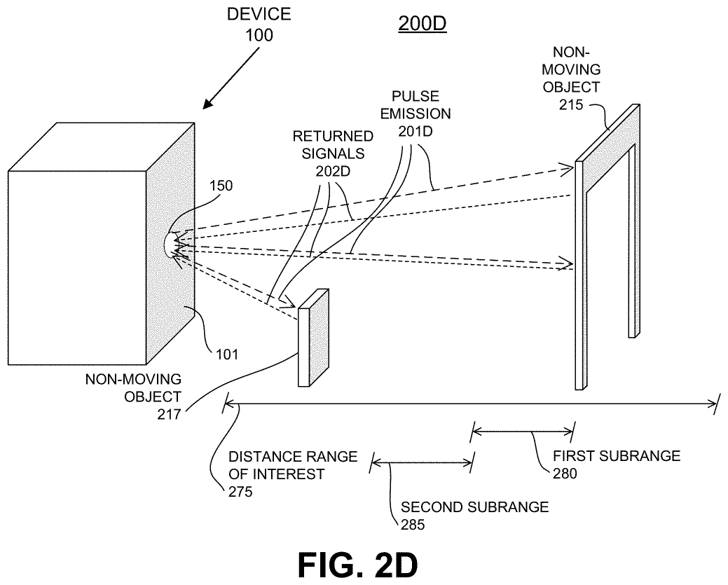

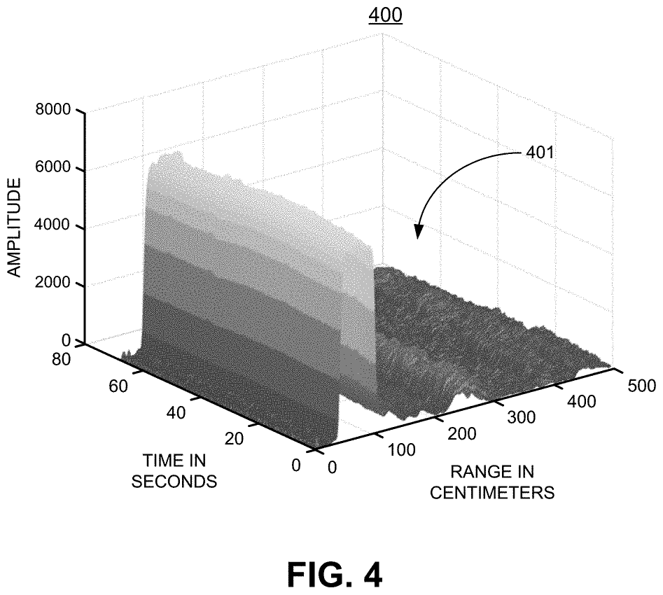

FIGS. 2A-2D depict a simplified diagram of a sensed environment 200 which, over time, has static (i.e., non-moving) and moving objects that correspond with returned signals and processed returned signals depicted in FIGS. 4, 5, and 7. FIGS. 2A-2D illustrate examples of changes in a sensed environment 200 over time (from 200A, to 200B, to 200C, and then to 200D). For example, in one embodiment, where an ultrasonic emit/receive duty cycle occurs every 10 mS for about 65 seconds: FIG. 2A represents the sensed environment 200A at a time period of about 0-40 seconds; FIG. 2B represents the sensed environment 200B at about 45 seconds; FIG. 2C represents the sensed environment 200C at about 48 seconds; and FIG. 2D represents the sensed environment 200D at between about 50 seconds and 65 seconds.

FIG. 2A shows an example external depiction of a device 100 using an ultrasonic transducer 150 to detect for objects, or a change of objects, in a sensed environment 200A, in accordance with various embodiments. As depicted, device 100 includes an external housing 101, but this is not required. Device 100 may be a non-moving device (e.g., a sensor fixed to a wall) or a moving device (such as a flying drone). In various embodiments, device 100 (whether moving or non-moving) remains static for a time period during which ultrasonic transducer 150 is detecting for a moving object in sensed environment 200. In various embodiments, the sensed environment 200A is an indoor space, such as a room within a building. For example, device 100 may be a security system or a robot attempting to detect moving objects in a room 200. As depicted, sensed environment 200A includes one or more non-moving objects (215, 217) within distance range of interest 275 in the sensing field of view of ultrasonic transducer 150. In the illustrated example distance range of interest encompasses the distance of the room which is in the field of view of ultrasonic transducer 150. By way of example and not of limitation, in one embodiment, non-moving object 215 may be the side profile of a table, which presents a very narrow profile to the transducer, while non-moving object 217 may be a chair with a vertical and highly reflective surface. Accordingly, in this example, non-moving object 217 is expected to generate higher amplitude returned signals than non-moving object 215, due to being more reflective and due to being closer to ultrasonic transducer 150 (although in some embodiments signals received at a later time which have reflected from objects at a greater distance may be amplified to compensate for diminishment in amplitude of the longer distance of roundtrip flight).

In some embodiments, the distance range of interest 275 may encompass the range between the maximum and minimum distances at which at object can be sensed by the ultrasonic transducer 150 or the distance available in a sensed environment 200 (e.g., transducer 150 may have a greater range that the size of the room). In some embodiments, distance range of interest 275 may only encompass the range in which a person or object can move (e.g., it may encompass a walking path through a room otherwise filled with obstacles such as boxes or furniture). The distance range of interest 275 may encompass several meters in some embodiments. In some embodiments, the distance range of interest 275 may be broken up into a one or a plurality of smaller subranges (such as first subrange 280 and second subrange 285) for analysis. Although two subranges are depicted, there may be more. A particular subrange may be very small, such as 5 to 10 centimeters, and its size may be related to the size of objects which are trying to be detected. For example, if an ultrasonic transducer is being used to detect small moving objects (such as house pets), a subrange may be a few to several centimeters. While if an ultrasonic transducer is being used to detect for a larger moving object, such as a human, the subrange may be larger, such as 50-100 centimeters. A subrange, in some embodiments, may be related to the dimension of the temporal variations which are expected and/or to the accuracy with which it is desired to locate a moving object. Any number of subranges may be utilized. Subranges may be selected to be any size, may be identical in size, or may vary in size.

As depicted, ultrasonic transducer 150 emits a pulse or other signal 201A (illustrated by larger dashed lines with an outbound orientation with respect to ultrasonic transducer 150) and, after ceasing the emission, receives corresponding returned signals 202A (illustrated by smaller dashed lines with an inbound orientation with respect to ultrasonic transducer 150) which correspond to the pulse emission 201A. Put differently, the returned signals are echoes which have reflected from objects with the distance range of interest 275, returned to, and received by ultrasonic transducer 150. Received returned signals 202A from sensed environment 200A would represent a background or steady state of sensed environment 200 and will represent items which do not move (such as walls) along with items which might be moved (such as furniture) but typically remain static over very short timeframes. In sensed environment 200A, the individual non-moving objects may be sensed based on the magnitude of received returned signals 202A that are received from distance ranges that correspond to non-moving object 215 and non-moving object 217. As will be further discussed, even if nothing new is added and no object moves through sensed environment 200A, there may be enough variability in the magnitudes of received returned signals 202A to influence the accuracy of presence and motion detection. This variability may be due to one or more of a variety of factors, which may include: sensor noise, temperature variations, air flow changes (e.g., caused by doors opening/closing, on/off cycling of an air conditioning system, wind through a window, etc.), and occasional slight displacement of objects in the sensed environment (e.g., rustling of a curtain, repositioning of a lamp on a table, etc.).

FIG. 2B shows an example external depiction of device 100 using ultrasonic transducer 150 to detect for objects sensed environment 200B into which a new object has entered, in accordance with various embodiments. Sensed environments 200A and 200B are similar (e.g., they are the same room or other indoor space). However, in sensed environment 200B, moving object 210 has entered the distance range of interest 275 and is within first subrange 280. It some embodiments, a moving object would include an object such as a human or an animal (such a house pet), but not a very small object such as a mosquito. For purposes of example, moving object 210 may be presumed to be moving toward device 100. Pulse emission 201B now results in received returned signals 202B, which also represent echoes from moving object 210 in subrange 280. As previously described, the variability in the background or steady state of sensed environment 200A along with the size of the moving object and its proximity to other objects can make it difficult, impractical, or impossible to detect changes or moving objects (e.g., moving object 210) in sensed environment 200B from the magnitudes of returned signals 202B.

FIG. 2C shows an example external depiction of device 100 using ultrasonic transducer 150 to detect for objects sensed environment 200B into which a new object has entered, in accordance with various embodiments. Sensed environments 200A, 200B, and 200C are similar (e.g., they are the same room or other indoor space). However, in sensed environment 200C, moving object 210 has moved within subrange 280 to be closer to device 100 than it was in FIG. 2B. Pulse emission 201C now results in received returned signals 202C, which also represent echoes from moving object 210 in subrange 280. As previously described, the variability in the background or steady state of sensed environment 200A can make it difficult, impractical, or impossible to detect changes or moving objects (e.g., moving object 210) in sensed environment 200B or sensed environment 200C from the magnitudes of returned signals 202B and 202C.

FIG. 2D shows an example external depiction of a device 100 using an ultrasonic transducer 150 to detect for objects a sensed environment 200A, in accordance with various embodiments. FIG. 2D is identical to FIG. 2A, except that it is a depiction of sensed environment 200 at a later time than FIG. 2A and thus pulse emission 201D and returned signals 202D occur later in time than corresponding pulse emission 201A and returned signals 202A.

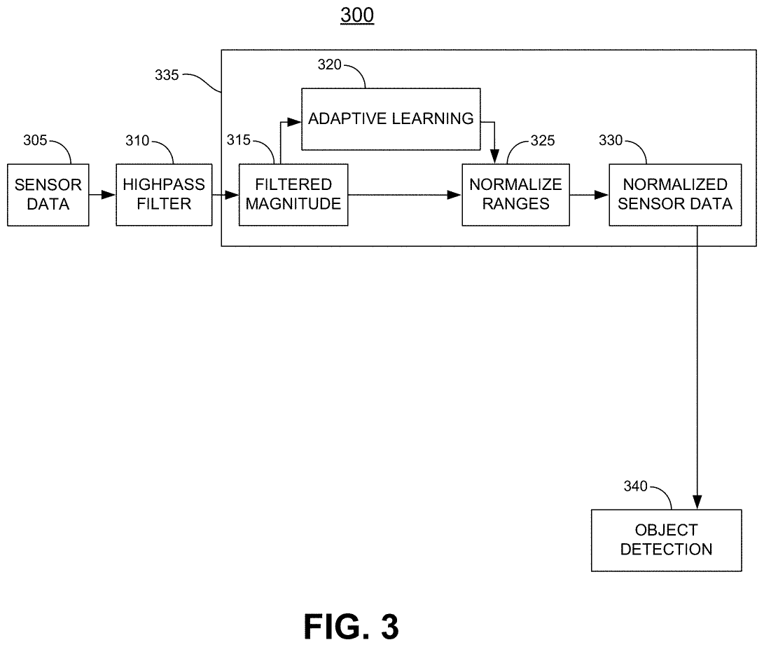

FIG. 3 illustrates a flow diagram 300 of a method of detecting the presence of a moving object with an ultrasonic transducer, in accordance with various embodiments. The method illustrated is adaptive in that it enables an ultrasonic transducer 150 to be environment agnostic and automatically update its baseline when or as a sensed environment (e.g., an indoor space such as a room in a building) changes. This adaptation to changes in the background and other aspects which remove or diminish signal contributions from static (i.e., stationary aspects) of a sensed environment's returned signals facilitate improved ability to detect changes (such as moving objects) in the sensed environment. The use of subranges within a distance range of interest also allows for adaptation to localized effects where the variation in the sensed environment may be different for different subranges. Reference will be made to FIGS. 4-8 during the description of flow diagram 300 of FIG. 3.

With continued reference to FIG. 3, at 305 sensor data from an ultrasonic transducer 150 is accessed. The accessing may comprise retrieving the sensor data from a storage location, automatically receiving the sensor data from ultrasonic transducer 150, requesting the sensor data from ultrasonic transducer 150 or another location such as a memory, or otherwise obtaining it. The sensor data is, in one embodiment, the returned signals from a sensed environment (e.g., an indoor space such as a room 200 over a period of time), which may be signals in a raw magnitude form after demodulation.

Referring now to FIG. 4, a graph 400 illustrates raw magnitudes of returned signals 401 received over a period of time (approximately 65 seconds) by an ultrasonic transducer 150 in a sensed environment such as a room (e.g., an indoor space such as sensed environment 200), in accordance with various embodiments. In an example with a sample rate of 10 Hz, graph 400 represents the amplitudes of approximately 650 returned signal samples over a range of interest of about 500 centimeters. As can be seen, a signal with very high amplitude peaks at around 100 centimeters. This peak may be from returned signals (202B) from attributed to a very close stationary object such as non-moving object 217 (which in some embodiments may be a chair with a highly reflective vertical surface). An additional small peak occurs at around 250 centimeters, but it is harder to discern due to other aspects with higher amplitude and due to variations in amplitude across the returned signals 401. Finally, a small peak occurs at around 450 centimeters, which may be associated with a farther away stationary object such as non-moving object 215.

Referring again to FIG. 3, at 310 frequency filtering (which may include high pass filtering) or a similar technique is applied to the received returned signals to remove static components (which may be low frequency components) of the returned signals. With an overall sample rate of 10 Hz, in various embodiments, the static frequency component may be below 3.5 Hz, below 3 Hz, below 2 Hz, below 1.5 Hz. A static or low frequency component below the pre-selected cutoff frequency is filtered out and removed to achieve modified returned signals for the distance range of interest. By way of example and not of limitation, and with reference to FIGS. 2A-2D, removal of the low frequency component will remove or greatly diminish returned signal contributions from non-moving objects 215 and 217 and other static (non-moving) aspects within sensed environment 200.

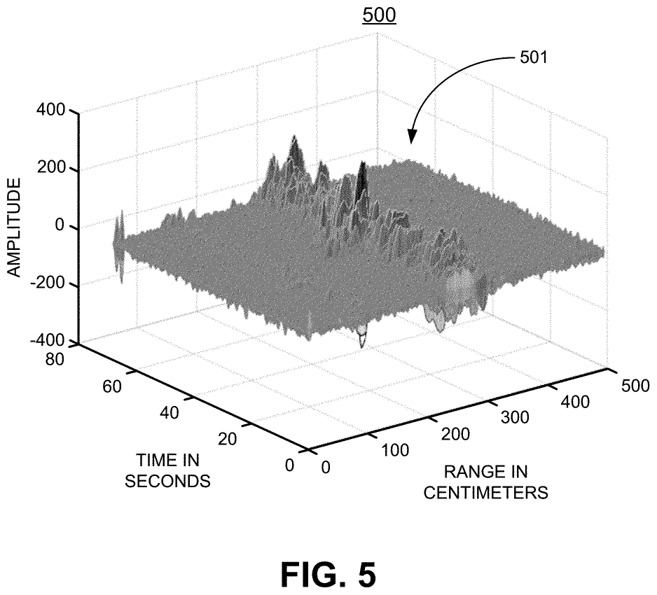

FIG. 5 illustrates a graph 500 of modified returned signals 501 after a low frequency component has been removed from the returned signals 401 of FIG. 4, in accordance with various embodiments. As can be seen, the range in amplitudes has been greatly diminished, but there is still a great deal of variability in a subrange between 200 and 300 centimeters away from the ultrasonic transducer 150. To smooth the returned signals more so that actual variability associated with a moving object can be detected, additional smoothing procedures are applied.

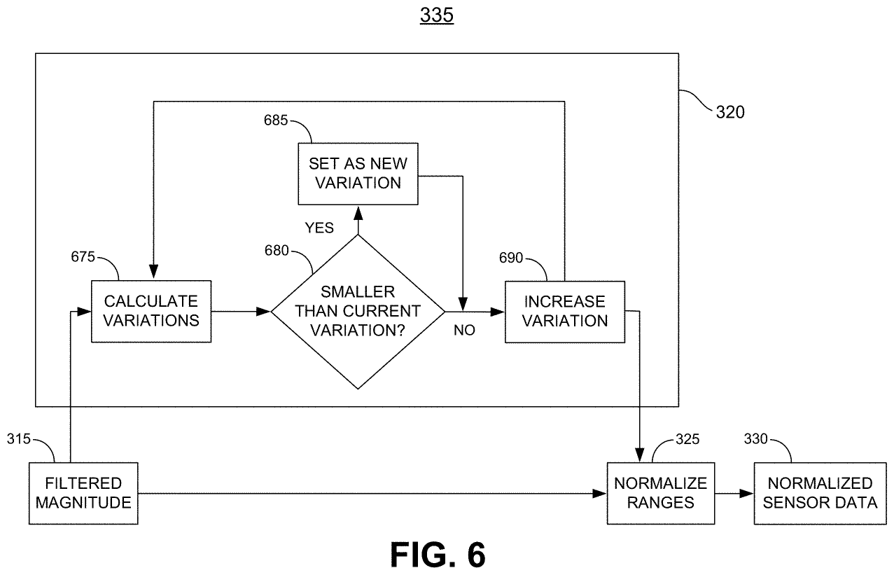

With reference again to FIG. 3, at block 315 the modified returned signals, which are magnitude signals which have had a low frequency component filtered out (i.e., “filtered magnitudes”), are provided to block 320 for adaptive learning of the variations and to block 325 for normalization of all signals in the distance range of interest or of one or more selected subranges. The adaptive learning generally involves calculating a variation in the amplitudes of the filtered magnitude signals for the modified returned signals. This may be done across the whole of the returned signals or by individual subranges. Once the quantity of the variation for a particular subrange is calculated (or else it is quantified from on overall variation calculation) that quantity of variation is used in block 325 to normalize the modified returned signals in that subrange. For example, if the quantity of the variation for a subrange was 100 units of amplitude variation, then that quantity would be used for normalization. The normalization in 325 may involve dividing the amplitude of the modified returned signals (i.e., the frequency filtered signals) for a particular subrange (e.g., first subrange 280) by the quantity of variation (e.g., variance) in amplitude of that subrange. The result is normalized sensor data for that subrange. This process may be repeated for other subranges up to the entirety of the range of interest in the modified returned signals. Other aspects, such as feedback may be incorporated to adapt continually over time to changes in the static (non-moving) aspects of a sensed environment. A more detailed block diagram of one example of adaptive learning 320 is illustrated in FIG. 6 and it includes the aspects of FIG. 3 located in block 335.

With reference to FIG. 6, a more detailed view of the functions of the adaptive learning portion of the flow diagram of FIG. 3 is illustrated, in accordance with various embodiments. In general, in one example embodiment, block 320 carries out a process of recursive filtering which reduces the need for buffering large amounts of data by maintaining and updating a variation over time. At block 675 of FIG. 6, variations are calculated for subranges (e.g., first subrange 280, second subrange 285, etc.) across a distance range of interest (e.g., 275) over a period of time. Thus, the variations are variations over time in the subranges. The variations may be calculated in any suitable manner. In one embodiment, the variations may be the raw variation between the smallest and largest amplitude in a distance range of interest for a particular emit/receive duty cycle of transducer 150. In another embodiment, the variation may be a variance calculated in a statistical manner as a deviation from the mean amplitude of individual amplitudes in a subrange for a particular emit/receive duty cycle of transducer 150. For example, a variance calculation may involve finding the arithmetic difference between each of the amplitude measurements in a subrange and the mean value of the amplitude measurements in the subrange for the duty cycle, squaring these values, totaling up the sum of these squared values, and dividing the total by one less than the number of data points (i.e., amplitude measurements) in the subrange. These are merely examples, and other techniques for calculating variation across a distance range of interest or subranges within the distance range of interest may be utilized. In general, though, a smaller variation is typically indicative of a “calmer” set of returned signals which has a lower presence of unwanted signal contributions (where unwanted signal contributions come from sources other than echoes from objects in the distance range of interest) and is thus more sensitive to detection of moving objects.

With continued reference to FIG. 6, at 680 the variation is compared to a previous variation to determine whether it is smaller. If it is not smaller, then the current variation remains in place and unchanged and is forwarded to block 690 where it is increased slightly then provided back to block 675 as the current variation for the next iteration comparison. If it is smaller, then in block 685 it is set as the new variation to replace the current variation. This variation iteration ensures that if the variation in a certain subrange decreases, this is detected and used for the variation. Because this iteration only works one way, an opposite mechanism is also needed. Therefore, in one embodiment, the newly determined variation is then forwarded to block 690 where it is increased slightly. The variation is also provided back to block 675 as the current variation for the next iteration of comparison. The order of the different steps can be different than shown. In an embodiment, where ultrasonic sensing takes place at 10 Hz, the iterations may be on data that is 100 ms apart in time.

The increases provided by block 690 may be referred to as a “forget factor” and may be a fixed amount or a small percentage (e.g., 1%, 2%, etc.) of the current variation. This deteriorates the variation over time (by gradually increasing its value over time) and results in a decrease in sensitivity to changes in the normalized sensor data. A smaller increase means that the system is less reactive to changes when the variations increases, e.g., when a moving object become present in the subrange (possible false negative). This increase eventually forces the system to update the background variance. A larger increase means that the system is more reactive, but may also become more noisy and overreactive (possible false positive). A high background variation is analogous to a noisy environment; where the noisier the environment the harder it is to detect movement in the returned signals.

In block 325 a quantification of the variation (e.g., a calculated variance) for a subrange is employed to correct for changes in the respective modified returned signals (e.g., high pass filtered data) for a subrange. The correction may involve dividing the modified returned signals in a subrange by the quantity of variation that has been determined for that subrange. In other words, the signals are normalized using the quantified variations for the respective subrange. This is repeated for other subranges in the distance range of interest and produces normalized sensor data for each subrange and for the entire distance range of interest for each emit/receive duty cycle of the ultrasonic transducer 150.

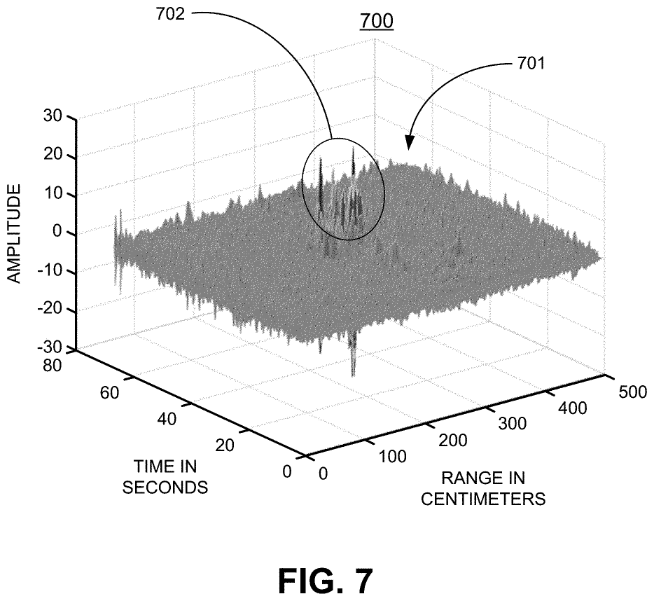

FIG. 7 illustrates a graph 700 of normalized sensor data 701 after set of modified returned signals (e.g., approximately 650 emit/receive duty cycles of transducer 150) has been corrected using variations calculated for the modified returned signals, in accordance with various embodiments. Note that the range over which amplitude varies in FIG. 7 is much smaller than the range over which amplitude varies in FIG. 5 due to the normalization. Note as well that the spikes in region 702 are more easily discerned as occurring at between 200 and 300 centimeters and as occurring at between about 40 and 50 seconds. The spikes in region 702 do not exist before or after this period of time.

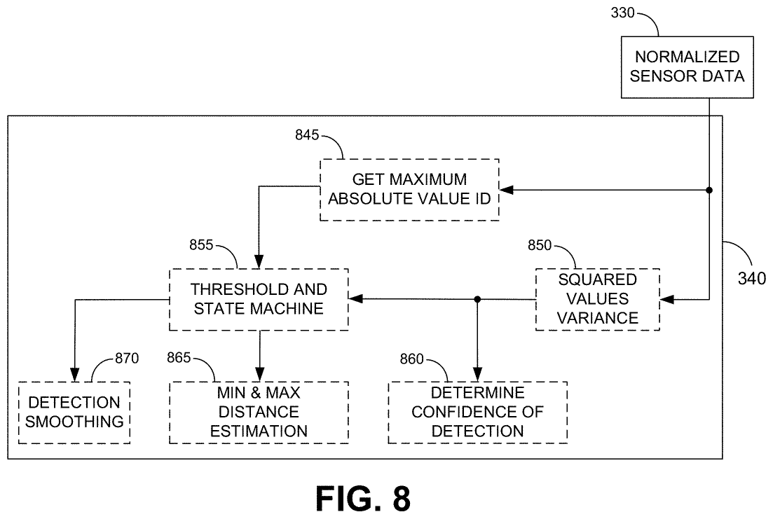

Referring again to FIG. 3, at block 340 the normalized sensor data 330 is analyzed to detect moving objects (if any). In one embodiment, this may comprise indicating that an object has been detected if a preset amplitude threshold for normalized sensor data within a subrange exceeds a threshold. This threshold may also be a normalized threshold, where the normalization of the threshold is also done using a quantity of the variation for the subrange. A plurality of subranges (e.g., first subrange 280, second subrange 285, etc.) may be analyzed in this manner to detect for moving objects at different distances from ultrasonic transducer 150. Additionally, or alternatively, other more sophisticated techniques may be employed to detect for moving objects using the normalized sensor data 330. An example embodiment of a moving object detection technique is illustrated in FIG. 8.

FIG. 8 illustrates a more detailed view of some aspects of the object detection portion of the flow diagram of FIG. 3, in accordance with various embodiments. In FIG. 8, object detection block 340 has been expanded according to one example embodiment. In one embodiment, detection for moving objects is performed on a subrange (e.g., for first subrange 280) of normalized sensor data 330 for an emit/receive duty cycle of transducer 150. The detection for a moving object can similarly be accomplished for second and additional subranges (e.g., for second subrange 285).

At block 845 a maximum absolute value for the analyzed normalized sensor data 330 is identified. The absolute value is used because some of the amplitudes of the normalized sensor data 330 may present as negative values (as illustrated in FIG. 7). Block 845 determines at what location the maximum in the signal is present and provides a smooth estimation of the distance of the object.

At block 850 a statistical variance from the average value is determined using squared values (which again compensates for negative values in the normalized data). This can be a standard technique of calculating a variance as might be used when calculating a standard deviation (which is typically expressed as the square root of variance). In some embodiments, when the variance exceeds a preset threshold, a moving object is confirmed as being detected in the analyzed normalized sensor data 330. This variance is an indication of how stable the detection of the object is and can be later used to determine a confidence of the detection. It should be appreciated that the variances calculated in 850 are variances in space (e.g., over the entire distance range of interest of a field of interest of a transducer). These variances over a space (e.g., over a distance range of interest) are different than the variations over time for a sub-range of the distance range of interest that were discussed in conjunction with FIG. 6 and in particular in conjunction with block 675, of FIG. 6. The squared values variances readily show how a peak in data differs from a background. Put differently, the variances show how a peak in a subrange differs from the whole range of interest of a transducer during an instant in time.

At block 855, the squared values variance is provided to a threshold and state machine. These squared values variances may be compared to existing values, to changes over time, and to threshold values to determine if a moving object has been detected in the normalized sensor data 330 being analyzed. The state machine may also determine that there should be a certain amount of consecutive positive occurrences of detection of a moving object or else a certain number in a number of samples (e.g., 7 out of 10 consecutive samples).

At block 860 the confidence of detection of a moving object in the analyzed normalized sensor data 330 is determined. The confidence is a value associated with the detection of the moving object. Generally, the higher the variance calculated in block 850, the greater the confidence that a moving object has been detected. The confidence may be expressed in a variety of ways, such as binary value or as a scaled value. For example, the confidence may be expressed as a binary value of 0 (low confidence) or a value of 1 (high confidence). In such an embodiment, the detection criterion (i.e., the squared variance value) is compared against a threshold which is used to compute the confidence. As another non-limiting example: when the criterion=threshold, confidence value=0; when the criterion>=10 times the threshold, the confidence value=1; and when the criterion is in between 0 and ten times the threshold, the confidence value is determined as a linear value between 0 and 1 along the line between the threshold and ten times the threshold value.

At block 865, in some embodiments, in response to initial detection of a moving object by threshold and state machine 855, the minimum and maximum distances of the object may be determined. These may be bounded by the distances associated with the subrange of data (e.g., first subrange 280) which is represented by the normalized sensor data 330. However, in some instances, the data may be additionally analyzed to determine a narrow maximum and minimum distance within the subrange. For example, if the subrange covered a distance between 200 and 300 centimeters from the ultrasonic transducer, further analysis of the data may show that amplitude spikes indicate the moving object is between 225 and 275 centimeters from the ultrasonic transducer 150. In some embodiments, if a particular distance from the transducer to the moving object is estimated or calculated from the time of flight of the underlying returned signals, a buffer (e.g., +/−5 centimeters; +/−10 centimeters, etc.) around this distance may be used to determine minimum and maximum distances to the moving object. In some embodiments, the subranges may be altered from wider to narrow subranges upon initial detection of a moving object. This may allow for a coarse initial detection and a finer location of the moving object after the initial detection.

At block 870, in some embodiments, in response to initial detection of a moving object by threshold and state machine 855, detection with ultrasonic transducer 150 may be paused for a predetermined period of time such as 0.5 seconds, 1 second, or 1.5 seconds and then restarted. When implemented, this pause facilitates additional smoothing of the global output of object detection block 340. This additional smoothing is on top of the smoothing provided by threshold and state machine 855.

### Example Methods of Operation

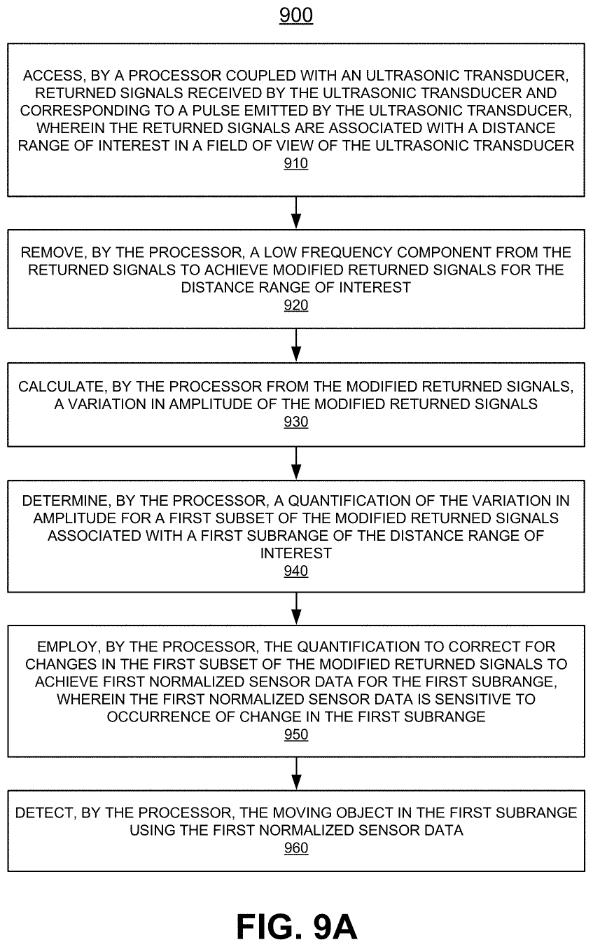

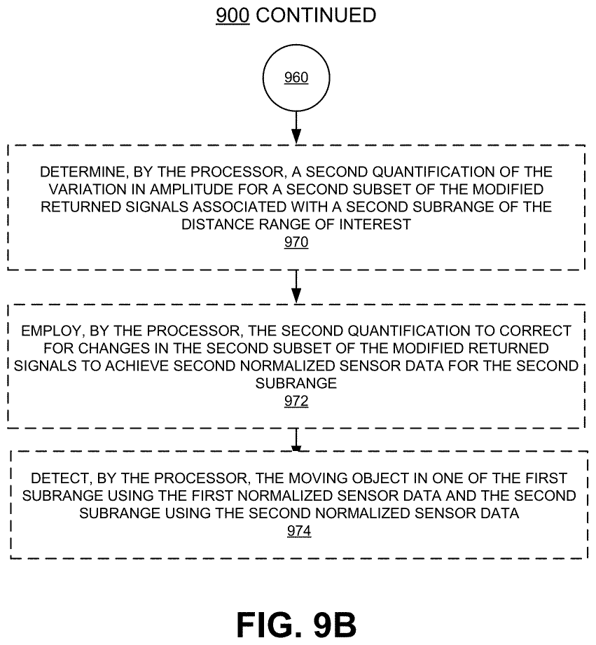

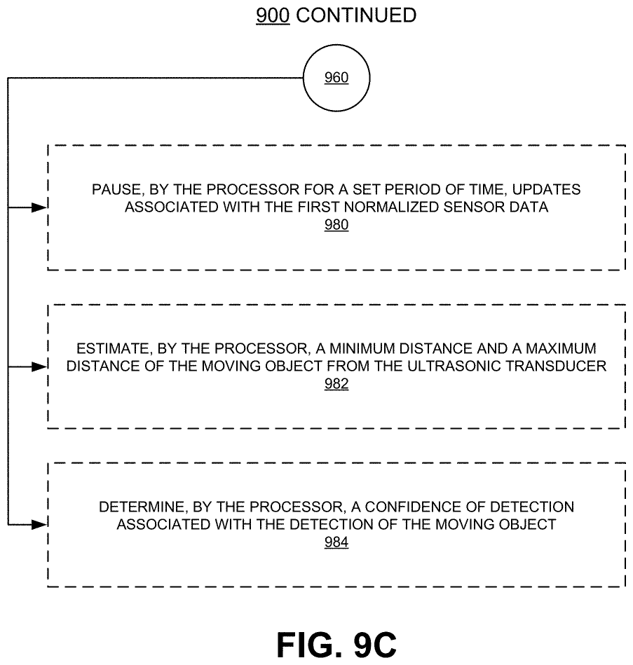

Procedures of the methods illustrated by flow diagram 900 of FIGS. 9A, 9B, and 9C will be described with reference to elements and/or components of one or more of FIGS. 1A-8. It is appreciated that in some embodiments, the procedures may be performed in a different order than described in a flow diagram, that some of the described procedures may not be performed, and/or that one or more additional procedures to those described may be performed. Flow diagrams 900 include some procedures that, in various embodiments, are carried out by one or more processors (e.g., processor 130, host processor 110, controller 151, a DSP, ASIC, ASIP, FPGA, or the like) under the control of computer-readable and computer-executable instructions that are stored on non-transitory computer-readable storage media (e.g., host memory 111, internal memory 140, or the like). It is further appreciated that one or more procedures described in flow diagram 900 may be implemented in hardware, or a combination of hardware with firmware and/or software.

FIG. 9A illustrates a flow diagram 900 of a method of detecting presence of a moving object with an ultrasonic transducer.

With reference to FIG. 9A, at procedure 910 of flow diagram 900, in various embodiments, returned signals are accessed that have been received by the ultrasonic transducer. The returned signals correspond to a pulse emitted by the ultrasonic transducer. The returned signals are associated with a distance range of interest in a field of view of the ultrasonic transducer. The ultrasonic transducer may be an ultrasonic transducer such as ultrasonic transducer 150 of FIGS. 1A and 1B. In various embodiments, the accessing is performed by a processor which is communicatively coupled with the ultrasonic transducer e.g., host processor 110, sensor processor 130, and/or controller 151—as shown in FIGS. 1A and 1B). In some embodiments, the “accessing” may involve the processor actively polling the ultrasonic transducer or a location where returned signals are stored to obtain the returned signals. In some embodiments, the “accessing” may involve the processor receiving returned signals which are forwarded from the ultrasonic transducer or from another source. The distance range of interest may be limited to all or some portion of the minimum and maximum distances at which an object in the field of view of an ultrasonic transducer can be sensed by the ultrasonic transducer. A distance range of interest 275 is illustrated in FIGS. 2A-2D.

With continued reference to FIG. 9A, at procedure 920 of flow diagram 900, in various embodiments, a low frequency component is removed from the returned signals to achieve modified returned signals for the distance range of interest. In various embodiments, the removing is performed by a processor which is communicatively coupled with the ultrasonic transducer (e.g., host processor 110, sensor processor 130, and/or controller 151). In some embodiments, the removal of the low frequency component may be accomplished by frequency filtering which may include high pass filtering of the returned signals.

With continued reference to FIG. 9A, at procedure 930 of flow diagram 900, in various embodiments, a variation in amplitude of the modified returned signals is calculated from the modified returned signals. In various embodiments, the calculating of the variation is performed by a processor which is communicatively coupled with the ultrasonic transducer (e.g., host processor 110, sensor processor 130, and/or controller 151). In some embodiments, the variation may be the distance between a maximum and minimum amplitude measured in modified returned signals for a subrange of the distance range of interest 275 associated with a transducer 150. In some embodiments, the variation is calculated as a statistical variance from a mean value of amplitude of the modified returned signals. The variance may be determined across a set of modified return signals associated with an emit/receive cycle of a transducer 150 or for one or more subranges of interest. The mean value may be a mean value for all of the modified returned signals received during the receive portion of an emit/receive duty cycle, or may be a mean value of a modified returned signals associated with a particular subrange (e.g., subrange 280, subrange 285, etc.) in the distance range of interest 275 associated with a transducer 150 and/or with the environment in which the transducer 150 is located.

In some embodiments the variation (which may be a statistical variance) in amplitude is compared with a previously determined variation in amplitude, and if the variation is smaller than the previously determined variation it is set as the new variance used for comparisons and it is increased a predetermined amount. If it is larger than a previously determined variation, the previously determined variation is kept and used for normalization and future comparison, but may also be increased slightly by a predetermined amount. The predetermined amount may be a multiplication factor which is close to 1 (e.g., 1.01 or 1.05) or may be a set whole number such as 1or 2. The amount of increase is selected to decay the variation used for comparison and normalizing and thus cause it to be updated with new data over time. The increase also deteriorates the variation in amplitude over time (by making it larger) to increase sensitivity to change of the normalized sensor data which is normalized by dividing values in the modified returned signals by the value of the variation. Put differently, the modified returned signals are normalized using the variation of the modified returned signals. Thus, changing the variation changes the result of normalization.

In some embodiments, normalization is accomplished separately for each identified subrange of a distance range of interest. For example, normalized sensor data for a first subrange of a distance range of interest is obtained by normalizing modified returned signals for the first subrange using a variation (which may be a statistical variance) calculated for the first subrange. This amount of the variation used needs to be identified or quantified. Put differently, when there are numerous subranges, the quantity of the variation associated with a particular subrange needs to be identified. The normalization may comprise dividing the values of the modified returned signals by the quantity of the variation. This can be similarly repeated for other subranges (e.g., for a second subrange, a third subrange, etc.) identified in a distance range of interest using the quantified variation and the modified returned signals associated with a particular subrange.

With continued reference to FIG. 9A, at procedure 940 of flow diagram 900, in various embodiments quantification of the variation in amplitude is determined for a first subset of the modified returned signals associated with a first subrange of the distance range of interest. In various embodiments, the determining of the quantification of the variation is performed by a processor which is communicatively coupled with the ultrasonic transducer (e.g., host processor 110, sensor processor 130, and/or controller 151). As discussed above, the quantity of variation (which may be statistical variance) for a particular subrange is identified and then employed as a divisor for values of modified returned signals associated with the particular subrange. The quantity of the variation may be deteriorated (which in this case means increased in value) over time to increase sensitivity to change of the first normalized sensor data.

With continued reference to FIG. 9A, at procedure 950 of flow diagram 900, in various embodiments, the quantification of the variation in amplitude is employed to correct for changes in the first subset of the modified returned signals to achieve first normalized sensor data for the first subrange, wherein the first normalized sensor data is sensitive to occurrence of change in the first subrange. As discussed above, the quantity of variation (which may be statistical variance) for a particular subrange is identified and then employed as a divisor for values of modified returned signals associated with the particular subrange. In various embodiments, the employing of the quantification in variation in amplitude is performed by a processor which is communicatively coupled with the ultrasonic transducer (e.g., host processor 110, sensor processor 130, and/or controller 151).

With continued reference to FIG. 9A, at procedure 960 of flow diagram 900, in various embodiments, the moving object is detected in the first subrange using the first normalized sensor data. In various embodiments, the detecting is performed by a processor which is communicatively coupled with the ultrasonic transducer (e.g., host processor 110, sensor processor 130, and/or controller 151). In some embodiments, the detection involves comparing a magnitude of the first normalized sensor data to a threshold and detecting the presence of a moving object when the magnitude of the first normalized sensor data is larger than the threshold. In other embodiments, the threshold may need to be exceeded by more than one measurement to increase confidence in the detection. In one embodiment, a plurality of the normalized sensor data for a subrange are required to exceed the threshold. In one embodiment, a plurality of normalized sensor data for a subrange in at least two successive emit/receive duty cycles of a transducer are required to exceed the threshold.

In some embodiments, the detection of a moving object in a distance range of interest may involve calculating a variance of the normalized sensor data for either a subrange of the distance range of interest or for the entire distance range of interest. This variance can then be compared to a threshold and responsive to the variance exceeding a threshold, a moving object is determined to have been detected. An example of this technique is described in 850 of FIG. 8.

With reference to FIG. 9B, at procedure 970 of flow diagram 900, in various embodiments, a second quantification of the variation in amplitude is determined for a second subset of the modified returned signals associated with a second subrange of the distance range of interest. This variation (which may be a variance) can be calculated in the same way for the second subrange as previously described, and the quantity identified in the same way as previously described in connection with the first subrange. In various embodiments, this quantification of the variation in amplitude is performed by a processor which is communicatively coupled with the ultrasonic transducer (e.g., host processor 110, sensor processor 130, and/or controller 151).

With continued reference to FIG. 9B, at procedure 972 of flow diagram 900, in various embodiments, the second quantification is employed to correct for changes in the second subset of the modified returned signals to achieve second normalized sensor data for the second subrange. As discussed above, the quantity of variation (which may be statistical variance) for the second subrange is identified and then employed as a divisor for values of modified returned signals associated with the second subrange. In various embodiments, the employing of the second quantification is performed by a processor which is communicatively coupled with the ultrasonic transducer (e.g., host processor 110, sensor processor 130, and/or controller 151).

With continued reference to FIG. 9B, at procedure 974 of flow diagram 900, in various embodiments, the moving object is detected in one of the first subrange (using the first normalized sensor data) and the second subrange (using the second normalized sensor data). Put differently, the normalized data in two or more subranges is evaluated to detect for moving objects. If a moving object is not detected by the evaluation of normalized data for one of the subranges, the normalized data for the other subrange is evaluated to detect for a moving object. In various embodiments, this detecting is performed by a processor which is communicatively coupled with the ultrasonic transducer (e.g., host processor 110, sensor processor 130, and/or controller 151).

With reference to FIG. 9C, at procedure 980 of flow diagram 900, in various embodiments, updates associated with the first normalized sensor data are paused for a period of time. The period of time for the pausing may be preset in some embodiments. Because data is collected at short intervals (e.g., at 10 Hz) a moving object such as a human will typically still be moving or at least present if data collection or updates are paused for a short period of time such as 0.5 to 1.5 seconds. The pausing can act to further smooth the motion detection outputs. Some examples of pausing updates are discussed in conjunction with 870 of FIG. 8. In various embodiments, this pausing is performed by or under instruction of a processor which is communicatively coupled with the ultrasonic transducer (e.g., host processor 110, sensor processor 130, and/or controller 151).

With continued reference to FIG. 9C, at procedure 982 of flow diagram 900, in various embodiments, one or more of a minimum distance and a maximum distance of the moving object from the ultrasonic transducer are estimated. The index of the maximum variability of the normalized data is used as a rough distance estimated. Then it is filtered over time to smooth the estimation. The minimum and maximum distance may be just a predefined range around the estimated distance (i.e., +/−10 cm). In some embodiments, the estimated distance is associated with the distance range of the subrange in which movement is detected. Some examples of estimating the minimum and maximum distance of a moving object from a transducer 150 are discussed in conjunction with 865 of FIG. 8. In various embodiments, this estimate of minimum and/or maximum distances is performed by a processor which is communicatively coupled with the ultrasonic transducer (e.g., host processor 110, sensor processor 130, and/or controller 151).

With continued reference to FIG. 9C, at procedure 984 of flow diagram 900, in various embodiments, a confidence of detection is determined. The confidence may be expressed as a binary value or on a scale of confidence between low and high. In some embodiments, the amount by which the threshold is exceeded is used to determine a confidence in the detection, where exceeding the threshold by a greater amount results in a greater confidence than only barely exceeding the threshold. Some examples of determining a confidence are discussed in conjunction with 860 of FIG. 8. In various embodiments, this determining is performed by a processor which is communicatively coupled with the ultrasonic transducer (e.g., host processor 110, sensor processor 130, and/or controller 151).

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A device comprising:
an ultrasonic transducer configured to emit an ultrasonic pulse and receive returned signals corresponding to the emitted ultrasonic pulse and associated with a distance range of interest in a field of view of the ultrasonic transducer; and
a processor coupled with the ultrasonic transducer and configured to:
remove a low frequency component from the returned signals to achieve modified returned signals for the distance range of interest;
calculate, from the modified returned signals, a variation in amplitude of the modified returned signals;
determine a quantification of the variation in amplitude for a first subset of the modified returned signals associated with a first subrange of the distance range of interest;
employ the quantification to correct for changes in the first subset of the modified returned signals to achieve first normalized sensor data for the first subrange, wherein the first normalized sensor data is sensitive to occurrence of change over time in the first subrange; and
detect a moving object in the first subrange using the first normalized sensor data.

2. The device of claim 1, wherein the processor is further configured to:
determine a quantification of the variation in amplitude for a second subset of the modified returned signals associated with a second subrange of the distance range of interest; and
employ the quantification to correct for changes in the second subset of the modified returned signals to achieve second normalized sensor data for the second subrange.

3. The device of claim 2, wherein the processor configured to detect the moving object in the first subrange using the first normalized sensor data further comprises the processor being configured to:
detect the moving object in one of the first subrange using the first normalized sensor data and the second subrange using the second normalized sensor data.

4. The device of claim 1, wherein the processor is further configured to:
estimate a minimum distance and a maximum distance of the from the ultrasonic transducer of the moving object.

5. The device of claim 1, wherein the processor is further configured to:
determine a confidence of detection associated with the detection of the moving object.

6. The device of claim 1, wherein the processor configured to determine a quantification of the variation in amplitude for a first subset of the modified returned signals associated with a first subrange of the distance range of interest comprises the processor being further configured to:
deteriorate the variation in amplitude over time to increase sensitivity to change of the first normalized sensor data.

7. A sensor processing unit comprising:
an ultrasonic transducer configured to emit an ultrasonic pulse and receive returned signals corresponding to the emitted ultrasonic pulse and associated with a distance range of interest in a field of view of the ultrasonic transducer; and
a sensor processor coupled with the ultrasonic transducer and configured to:
remove a low frequency component from the returned signals to achieve modified returned signals for the distance range of interest;
calculate, from the modified returned signals, a variation in amplitude of the modified returned signals;
determine a quantification of the variation in amplitude for a first subset of the modified returned signals associated with a first subrange of the distance range of interest;
employ the quantification to correct for changes in the first subset of the modified returned signals to achieve first normalized sensor data for the first subrange, wherein the first normalized sensor data is sensitive to occurrence of change over time in the first subrange; and
detect a moving object in the first subrange using the first normalized sensor data.

8. The sensor processing unit of claim 7, wherein the sensor processor is further configured to:
determine a quantification of the variation in amplitude for a second subset of the modified returned signals associated with a second subrange of the distance range of interest; and
employ the quantification to correct for changes in the second subset of the modified returned signals to achieve second normalized sensor data for the second subrange.

9. The sensor processing unit of claim 8, wherein the sensor processor configured to detect the moving object in the first subrange using the first normalized sensor data further comprises the sensor processor being configured to:
detect the moving object in one of the first subrange using the first normalized sensor data and the second subrange using the second normalized sensor data.

10. The sensor processing unit of claim 7, wherein the sensor processor is further configured to:
estimate a minimum distance and a maximum distance of the from the ultrasonic transducer of the moving object.

11. The sensor processing unit of claim 7, wherein the sensor processor is further configured to:
determine a confidence of detection associated with the detection of the moving object.

12. The sensor processing unit of claim 7, wherein the sensor processor configured to determine a quantification of the variation in amplitude for a first subset of the modified returned signals associated with a first subrange of the distance range of interest comprises the sensor processor being further configured to:
deteriorate the variation over time to increase sensitivity to change of the first normalized sensor data.

13. A method of detecting presence of a moving object with an ultrasonic transducer, the method comprising:
accessing, by a processor coupled with an ultrasonic transducer, returned signals received by the ultrasonic transducer and corresponding to a pulse emitted by the ultrasonic transducer, wherein the returned signals are associated with a distance range of interest in a field of view of the ultrasonic transducer;
removing, by the processor, a low frequency component from the returned signals to achieve modified returned signals for the distance range of interest;
calculating, by the processor from the modified returned signals, a variation in amplitude of the modified returned signals;
determining, by the processor, a quantification of the variation in amplitude for a first subset of the modified returned signals associated with a first subrange of the distance range of interest;
employing, by the processor, the quantification to correct for changes in the first subset of the modified returned signals to achieve first normalized sensor data for the first subrange, wherein the first normalized sensor data is sensitive to occurrence of change in the first subrange; and
detecting, by the processor, the moving object in the first subrange using the first normalized sensor data.

14. The method as recited in claim 13, further comprising:
determining, by the processor, a second quantification of the variation in amplitude for a second subset of the modified returned signals associated with a second subrange of the distance range of interest; and
employing, by the processor, the second quantification to correct for changes in the second subset of the modified returned signals to achieve second normalized sensor data for the second subrange.

15. The method as recited in claim 14, wherein the detecting, by the processor, the moving object in the first subrange using the first normalized sensor data further comprises:
detecting, by the processor, the moving object in one of the first subrange using the first normalized sensor data and the second subrange using the second normalized sensor data.

16. The method as recited in claim 13, further comprising:
estimating, by the processor, a minimum distance and a maximum distance of the moving object from the ultrasonic transducer.

17. The method as recited in claim 13, further comprising:
determining, by the processor, a confidence of detection associated with the detection of the moving object.

18. The method as recited in claim 13, wherein the calculating, by the processor, from the modified returned signals, a variation in amplitude of the modified returned signals comprises:
determining, by the processor, a variance of the modified returned signals.

19. The method as recited in claim 18, further comprising:
comparing, by the processor, the variance with a previously determined variance, and if the variance is larger than the previously determined variance, increase the variance by a predetermined amount.

20. The method as recited in claim 18, wherein the employing, by the processor, the quantification to correct for changes in the first subset of the modified returned signals to achieve first normalized sensor data for the first subrange, wherein the first normalized sensor data is sensitive to occurrence of change in the first subrange comprises:
normalizing, by the processor, the modified returned signals using the variance of the modified returned signals to obtain the first normalized sensor data for the first subrange.

21. The method as recited in claim 13, wherein the determining, by the processor, a quantification of the variation in amplitude for a first subset of the modified returned signals associated with a first subrange of the distance range of interest further comprises:
deteriorating, by the processor, the variation over time to increase sensitivity to change of the first normalized sensor data.

22. The method as recited in claim 13, wherein the detecting, by the processor, the moving object in the first subrange using the first normalized sensor data comprises:
comparing, by the processor, a magnitude of the first normalized sensor data to a threshold; and
detecting, by the processor, the moving object when the magnitude of the first normalized sensor data is larger than the threshold.

23. The method as recited in claim 22, wherein the detecting a moving object when the magnitude of the first normalized sensor data is larger than the threshold comprises:
detecting, by the processor the moving object when the magnitude of the first normalized sensor data is larger than the threshold for a plurality of first normalized sensor data.

24. The method as recited in claim 13, wherein the detecting, by the processor, the moving object in the first subrange using the first normalized sensor data comprises:
calculating, by the processor, a variance of the first normalized sensor data in the distance range of interest; and
responsive to the variance exceeding a threshold, detecting, by the processor, the moving object.
